(19) United States
(12) Patent Application Publication
(10) Pub. No.: US 2007/0116008 A1
(43) Pub. Date: May 24, 2007

(54) Second-order hubbing-and-grooming constrained by demand categories

(75) Inventors: Miguel Tomas Molina, San Ramon, CA (US); Christine Bouamalay, Oakland, CA (US); Ali Zolfaghari, San Ramon, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/284,770

(22) Filed: Nov. 22, 2005

(51) Int. Cl. H04L 12/56

(52) U.S. Cl. 370/395.21; 370/230

(57) ABSTRACT

An end-to-end demand between a pair of nodes of a telecommunication network is determined is categorized into a category based on hub assignments for the nodes. A route for the end-to-end demand in the telecommunication network is determined using a hubbing-and-grooming algorithm. The hubbing-and-grooming algorithm constrains which one or more links are eligible to be considered in determining the route based on the category of the end-to-end demand.

### FIELD OF THE DISCLOSURE

The present disclosure is generally related to methods and systems for hubbing and grooming of telecommunication networks.

### BACKGROUND

Hubbing-and-grooming algorithms are performed to provision end-to-end customer demands within a supporting telecommunication network infrastructure. The hubbing-and-grooming algorithms provision and route the end-to-end customer demands based on other input parameters such as hubbing assignments, grooming assignments, gateway assignments, and one or more thresholds. If changes are made to input parameters other than the thresholds, an undesirable amount of rework effort is required even if the algorithm has been completed according to its original specifications.

### BRIEF DESCRIPTION OF THE DRAWINGS

FIG. 1 is a block diagram of an embodiment of a system for implementing the second-order hubbing-and-grooming algorithm;

FIG. 2 is a block diagram illustrating different link types;

FIG. 3 is a flow chart of an embodiment of a method of performing a second-order hubbing-and-grooming algorithm;

FIG. 4 is a flow chart of an embodiment of a method of improving a second-order hubbing-and-grooming algorithm;

FIG. 5 is a block diagram of a first category of end-to-end demand within a data network;

FIG. 6 is a block diagram of a second category of end-to-end demand within a data network;

FIG. 7 is a block diagram of a first case in a third category of end-to-end demand within a data network;

FIG. 8 is a block diagram of a second case in a third category of end-to-end demand within a data network;

FIG. 9 is a block diagram of a fourth category of end-to-end demand within a data network;

FIG. 10 is a block diagram of a fifth category of end-to-end demand within a data network;

FIG. 11 is a block diagram of a sixth category of end-to-end demand within a data network;

FIG. 12 is a flow chart of an embodiment of a method of grooming based on the six categories; and

FIG. 13 is a block diagram of an illustrative embodiment of a general computer system.

### DETAILED DESCRIPTION OF THE DRAWINGS

Disclosed herein are embodiments of methods and systems for improving second-order hubbing-and-grooming algorithms by categorizing the end-to-end demands based on hubbing, grooming and/or gateway assignments. The possible categories represent scenarios of all possible routing configurations based on the assignments. Decisions on which links are eligible for use in a respective route for an end-to-end demand are constrained based on which category the end-to-end demand is within. Categorizing the end-to-end demands enables easier recalculations when input parameters and/or assumptions are modified (e.g. when the designation of hubbing, grooming and/or gateway nodes are changed, or when quantities and/or endpoints of initial demands are changed). Further, a final routing for all initial end-to-end demands is immediately available.

The algorithm can be applied at different levels; for example, to hub and groom DS1/VT1.5 demands to Synchronous Transport Signal Level 1 (STS-1); or to hub and groom various STS levels (STS-x), Optical Carrier levels (OC-x), and Gigabit Ethernet demands to lambda levels. The specific approach described herein for second-order hubbing-and-grooming can be implemented in any conventional computer language, such as C, C#, Java, or PERL, to solve various instances of the problem.

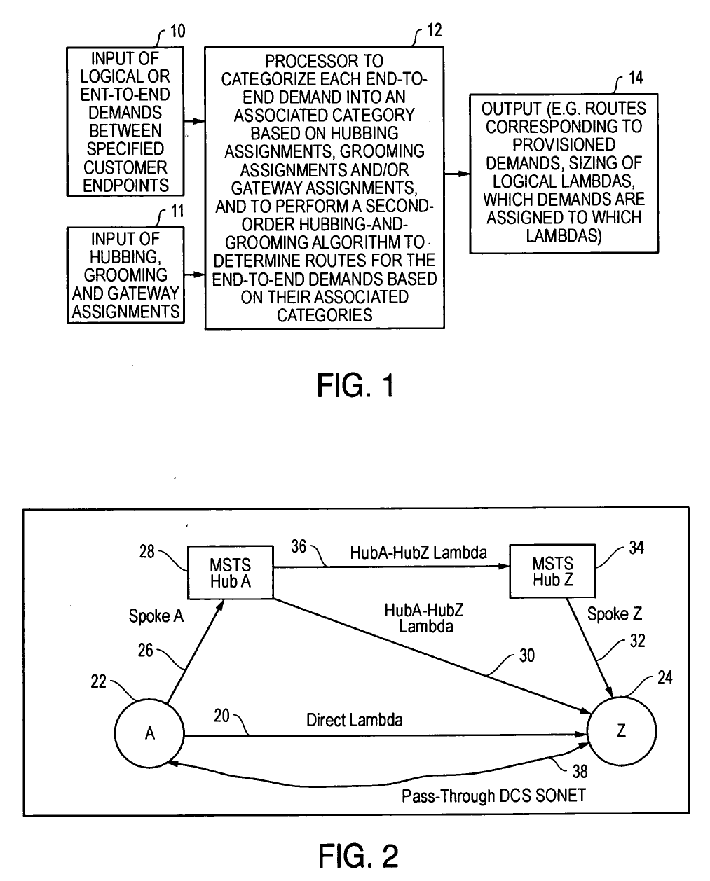

FIG. 1 is a block diagram of an embodiment of a system for implementing the second-order hubbing-and-grooming algorithm. An input 10 to the system comprises a number of logical or end-to-end demands specified between customer endpoints. The demands represent different levels of higher and lower bandwidth services sold to customers. Each demand specifies a level, which has a well-defined mapping to the bandwidth required, and a quantity of units.

Although described herein for guaranteed, constant-bandwidth services, the approach may be extended to cover differentiated services given adequate support from the underlying network implementation. For example, instead of a simple one-to-one mapping between the demand level and an amount of bandwidth, statistical multiplexing can be used.

All demands carry bi-directional traffic, and hence are symmetrical. One end of each demand may be arbitrarily designated an “A” or starting endpoint, and the other a “Z” or terminating endpoint. Input demands may specify the starting and terminating endpoints to be identical.

Projected quantities for each demand are supplied across standard intervals of time, for example, quantities needed by the end of each of the next four years. In the following examples, intervals are assumed to be one year in length, and the sequence of projected quantities non-decreasing, although the approach can be extended to remove these assumptions (for example, by using linear interpolation to normalize quantities).

Another input 11 to the system comprises hubbing, grooming and gateway assignments. These assignments are described in more detail later in this disclosure.

A processor 12 is responsive to the inputs 10 and 11 to perform the second-order hubbing-and-grooming algorithm. The second-order hubbing-and-grooming algorithm is to provision the end-to-end customer demands to either optimally or near-optimally utilize a supporting network infrastructure, and to produce an output 14 based thereon. The network infrastructure comprises multiple company offices containing appropriate switching and multiplexing equipment and interconnecting optical links, all with more than sufficient capacity to satisfy the given demand set. The algorithm calculates capacity and growth requirements for the infrastructure equipment and interconnections. The algorithm further determines a physical route assigned to each demand, that is, which infrastructure components are passed through in providing the required bandwidth service between its two customer endpoints.

Using the processor 12, all end-to-end demands are aggregated. Due to the symmetric nature of demands, endpoint names can be canonicalized in alphabetical order to consolidate those between identical endpoints. For example, one unit of OC-3 demand between endpoints B and X may be aggregated with one unit of OC-3 demand between endpoints X and B, resulting in two units of OC-3 demands between B and X, designated by its pair of canonicalized endpoints, “B-X”.

Next, a set of infrastructure company office nodes is designated. These company offices are selected from the same set of elements from which customer endpoints are selected without further constraints. Although most customer endpoints are distinct from company endpoints, company offices may serve as demand endpoints. In the following, endpoints and infrastructure nodes are designated by arbitrary one or two-character names such as “B”, “X”, “AB”. The names permit a unique alphabetical ordering such as “A”, “AB”, “B” and “X”, for example.

A pre-selection process matches the set of customer demands with the set of company offices such that the most appropriate entry point for both ends of all demands will be selected as the corresponding serving wire center, that is, the company office to which each customer endpoint is assigned. This is determined based on geographic considerations and/or by the types or scale of services required. For example, network providers often designate a static “homing” or “serving wire center” assignment whereby each customer endpoint is “homed to” or “served by” a designated company office.

Company offices are divided into two groups: on-net and off-net. On-net offices are those for which each given individual network planner is designated as responsible for allocating network resources. Off-net offices are those for which other network planners have been designated responsible in the same capacity.

Demands for which an end originates or terminates at a customer endpoint/company office excluded from the given individual network planner's area of responsibility (i.e. one endpoint is off-net and the other is on-net) are assigned to an included company office as an on-net “gateway”. For purposes of hubbing and grooming, these demands are considered to originate at the designated gateway so that the facilities required between the off-net endpoint and the gateway are not provisioned by this algorithm. Initial demands for which both originating and terminating customer endpoints' serving wire centers are off-net are excluded from further consideration.

All company offices are capable of being designated as gateways, grooming, and/or hubbing nodes, based on the presence of enabling network equipment, geographic proximity, traffic patterns, and the discretion of a network planner. In the following description, an office designated as a hub is assumed to serve as a hub for any traffic originating or terminating at the same office, but this assumption may be removed with no impact.

Schemes also are available to partially or fully automate the assignment of grooming, hubbing, and gateways nodes. Such assignments are assumed to be static, but the approach may be extended to account for dynamic hubbing, given support from the underlying network configuration.

Traffic demands are assumed to be non-uniformly distributed across endpoints. Infrastructure resources are likewise assumed to be non-uniformly distributed across and between company offices. In particular, the infrastructure is not assumed to be configured as full-mesh.

Grooming is defined as multiplexing sets of lower-level bandwidth traffic destined to the same next endpoint (whether intermediate or final) to higher-level bandwidth traffic. Hubbing is defined as back-hauling lower-bandwidth traffic to designated intermediate nodes in order to concentrate traffic and increase average utilization.

Without loss of generality, the method and system are described for an application of generating optical routes for a number of demands of various types going from a company-office-A to a company-office-Z. Each original end-to-end demand may be classified as one of the following types: Synchronous Transport Signal Level 1 (STS1) for either channelized or high-capacity Digital Service Level 3. (DS3); STS Concatenated (STS3c through STS192c) for transmission over OC-n optical fibers; and Gigabit Ethernet (GbE) of various rates and bandwidths (e.g. 1 GbE which is equivalent to 21 STS1 or 10 GbE which is equivalent to 210 STS1). The algorithm is used to determine if and when these demands can be sent over first lambda or second lambda optical routes either directly from company-office-A to company-office-Z, or indirectly by routing through an MSTS Hub for company-office-A and/or an MSTS Hub for the company-office-Z. The second lambda is a higher speed than the first lambda. For example, the first lambda may be about 2.5 Gigabits per second, and the second lambda may be about 10 Gigabits per second.

Links between nodes in the telecommunication infrastructure can be classified into six different link types: a direct lambda link; a spoke-A; a hub-A-to-Z lambda; a hub-A-to-hub-Z lambda; a spoke-Z; and a direct SONET link.

FIG. 2 is a block diagram illustrating the different link types. A direct lambda link 20 directly links an A-node 22 and a Z-node 24. A spoke-A 26 links the A-node 22 to its designated hub-A 28. A hub-A-to-Z lambda 30 links the hub-A 28 to the Z-node 24. A spoke-Z 32 links the Z-node 24 to its designated hub-Z 34. A hub-A-to-hub-Z lambda 36 links the hub-A 28 and the hub-Z 34. A direct SONET link 38 provides a pass-though to SONET network facilities to link the A-node 22 and the Z-node 24 directly as viewed from the perspective of the optical network. However, as viewed from the perspective of the SONET network, the direct SONET link 38 may be decomposable into a series of intermediate links.

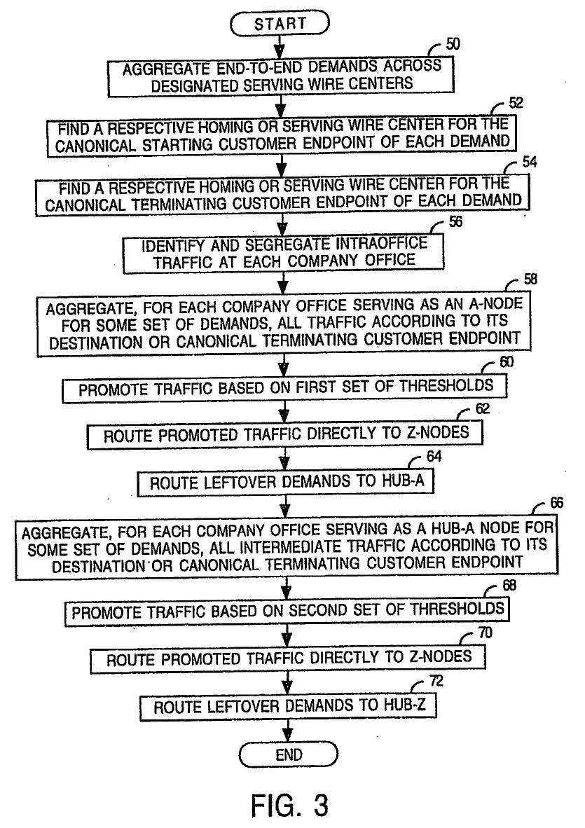

FIG. 3 is a flow chart of an embodiment of a method of performing a second-order hubbing-and-grooming algorithm. The method may be directed by software in a computer-readable medium and performed by the processor 12 in FIG. 1.

As indicated by block 50, the method comprises aggregating all end-to-end demands across designated serving wire centers (that is, initial infrastructure nodes assigned to both customer endpoints).

As indicated by block 52, the method comprises finding a respective homing or serving wire center for the canonical starting customer endpoint of each demand. This respective homing or serving wire center may be designated as an A-node of its respective demand.

As indicated by block 54, the method comprises finding a respective homing or serving wire center for the canonical terminating customer endpoint of each demand. This respective homing or serving wire center may be designated as a Z-node of its respective demand.

As indicated by block 56, the method comprises identifying and segregating all intraoffice traffic at each company office. Intraoffice traffic has demands whose A-node and Z-node are identical. These demands require utilization of company resources but no further routing or provisioning across links.

As indicated by block 58, the method comprises aggregating, for each company office serving as an A-node for some set of demands, all traffic according to its destination or canonical terminating endpoint (the Z-node).

As indicated by block 60, the method comprises promoting traffic based on a first set of thresholds. The first set of thresholds are parameters which represents fill percentages specified for qualifying traffic to a higher-level bandwidth pipe. These thresholds, typically around 50% in some embodiments, may be either specified by network planners or determined by company standards or by an automated inference process. For each bundle of same-level demands with a common destination, this act promotes the bundle to an appropriate higher bandwidth pipe if the fill percentage quantity exceeds the given threshold. This act of promoting produces two sets of demands: (a) those to be routed directly by higher-level bandwidth pipes; and (b) leftover demands which did not qualify for promotion because their fill percentage quantities were lower than the first set of thresholds.

As indicated by block 62, the promoted traffic is to be routed directly to the Z-nodes. As indicated by block 64, the leftover demands are to be routed to a designated hub, Hub-A, for each “A” company office.

As indicated by block 66, the method comprises aggregating, at each company office serving as a Hub-A node for some set of demands, all intermediate traffic according to its destination or canonical terminating customer endpoint.

As indicated by block 68, the method comprises promoting traffic based on a second set of thresholds. The second set of thresholds are parameters which represents fill percentages that may have the same or different values as the first set of thresholds and/or may be set according to different or the same criteria. Again, for each bundle of same-level demands with a common destination, this act promotes the bundle to an appropriate higher bandwidth pipe if the fill percentage quantity exceeds the given threshold.

As indicated by block 70, these promoted traffic bundles are to be routed directly by higher-level bandwidth pipes to the Z-nodes. As indicated by block 72, those traffic bundles which did not qualify for promotion are to be routed at the same bandwidth level to a designated hub office for each “Z” company office, called Hub-Z. Since this is a second-order hubbing-and-grooming algorithm, all traffic at Hub-Z company offices will be aggregated to common Z-node destinations and routed accordingly at the given lower levels since the second set of thresholds has not been met.

This hubbing-and-grooming algorithm is called second-order because it can introduce up to two levels of hubbing for each demand grouping. If the first grooming in Hub-A does not provide enough demand to build a direct lambda pipe between Hub-A and Hub-Z, the demand is routed (using a Hub-A-to-Hub-Z lambda) to the second hub to be groomed.

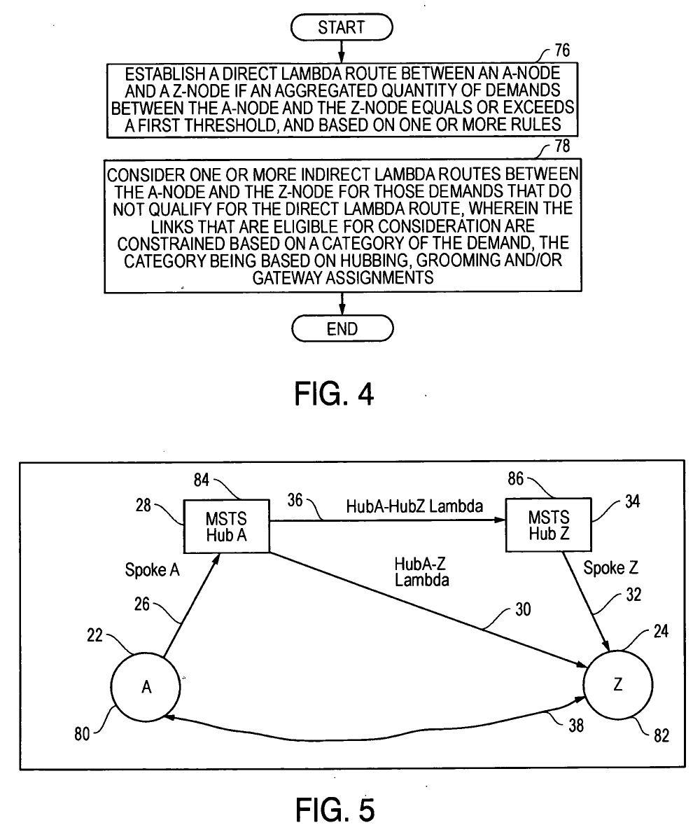

FIG. 4 is a flow chart of an embodiment of a method of improving a second-order hubbing-and-grooming algorithm. The acts shown in FIG. 4 are performed based on a plurality of end-to-end demands between pairs of nodes of a telecommunication network, and hubbing, grooming and gateway assignments for the nodes. The method may be directed by software in a computer-readable medium and performed by the processor 12 in FIG. 1. The acts in FIG. 4 can replace all or some of the hubbing and grooming acts in FIG. 3.

As indicated by block 76, the method comprises establishing a direct lambda route between an A-node and a Z-node if an aggregated equivalent STS1 quantity of demands between the A-node and the Z-node equals or exceeds a pre-established first threshold. The aggregated equivalent STS1 quantity of demands may be for a target year other than a base year. The target year may be about two years later than a base year for the demand forecast. The first threshold may be a variable that is set by a user when running the software. For example, the first threshold may be set to 48 STS1.

Establishment of the direct lambda route is further based on one or more rules. The one or more rules are used to determine whether all or some of the demands are to be sent via the direct lambda route, and to determine a quantity of either the first lambda or the second lambda that is required as an additional route. Examples of the rules include: maximizing the utilization of lambda routes selected; processing demands in a demand group based on the highest equivalent STS1; providing the second lambda when the demand-equivalent STS1 exceeds a second threshold; upgrading to the second lambda if more than some fixed multiple of (e.g. three times) the first lambda is required; decreasing remaining aggregated equivalent STS1 under consideration for direct routing for processed demands (i.e. a demand after being assigned to the direct lambda route) in a group. When additional demands are considered for routing but the capacity of the provisioned lambda is not sufficient and the remaining aggregated equivalent STS1 is less than the first threshold, then these demands are not routed via a direct lambda route and additional lambda capacity is not provided.

Like the first-threshold, the second threshold may be a variable that is set by the user when running the software. For example, the second threshold may be set to 210 STS1. In general, the second threshold is greater than or equal to the first threshold.

As indicated by block 78, the method comprises considering indirect lambda routes between the A-node and the Z-node when the aggregated equivalent STS1 quantity of the demands between the A-node and the Z-node for the target year is less than the first threshold or if at least one rule for using the direct lambda route has failed. These indirect lambda routes are called hubbing paths because of their path through at least one hub.

The hubbing paths may comprise a first-order hubbing path through the spoke-A 26 and the hub-A-to-Z lambda 30. This first-order hubbing path is used for some or all demands that are not to be routed directly. The hubbing paths may further comprise a second-order hubbing path through the spoke-A 26, the hub-A-to-hub-Z lambda 36 and the spoke-Z 32. The second-order hubbing path is used for those demands that are not to be routed directly or routed through the first-order hubbing path. In general, a first-order hubbing path is a path through one hub, and a second-order hubbing path is a path through two hubs.

The logic for determining which indirect lambda route to use is based on a categorization of the end-to-end demand. The end-to-end demands are categorized into one of a plurality of different categories based on the hubbing, grooming and/or gateway assignments for the nodes. In some embodiments, six different categories are used to categorize the end-to-end demands. The particular links that are eligible for consideration in determining a respective route for each of these end-to-end demands are constrained based on its associated category. FIGS. 5-11 illustrate the six different categories, and describe how to constrain which links are eligible for use in the hubbing-and-grooming algorithm to determine the respective routes.

FIG. 5 is a block diagram of a first category of end-to-end demand. In the first category, the A-node 22, the Z-node 24, the hub-A 28 and the hub-Z 34 are at four different company offices 80, 82, 84 and 86, respectively. For the first category, an attempt is made to dispatch qualifying demands via a first-order hubbing route. If this attempt fails, demands are sent via a second-order hubbing route. Thereafter, any remaining demands are sent via the direct SONET link 38.

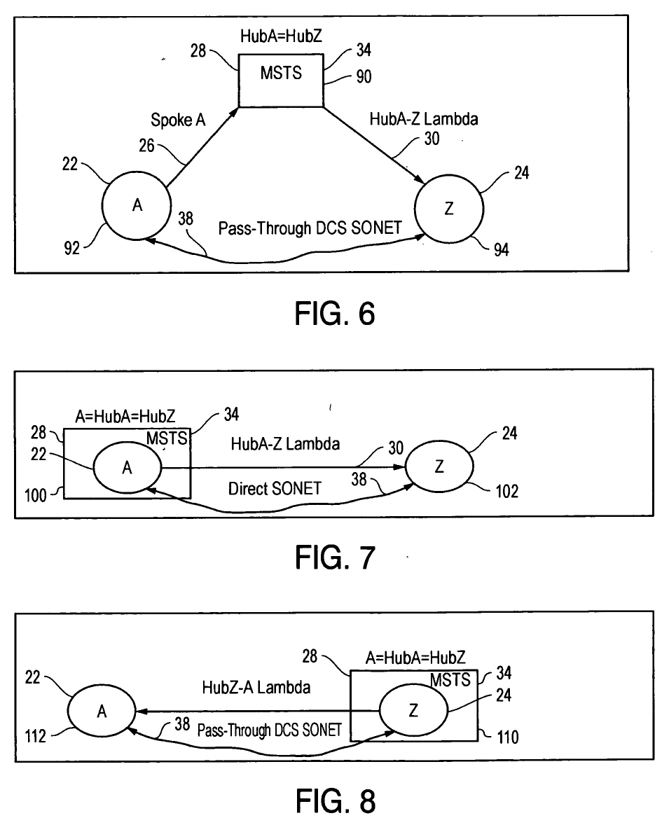

FIG. 6 is a block diagram of a second category of end-to-end demand. In the second category, the hub-A 28 and the hub-Z 34 are both at a company office 90, but the A-node 22 and the Z-node 24 are at two other company offices 92 and 94, respectively. For the second category, an attempt is first made to dispatch qualifying demands via a first-order hubbing route and remaining demands are sent via the direct SONET link 38.

FIG. 7 is a block diagram of a first case in a third category of end-to-end demand. Here, the hub-A 28, the hub-Z 34 and the A-node 22 are all at a company office 100, but the Z-node 24 is at a different company office 102. For the first case of the third category, demands are sent via the direct SONET link 38.

FIG. 8 is a block diagram of a second case in the third category of end-to-end demand. Here, the hub-A 28, the hub-Z 34 and the Z-node 24 are all at a company office 110, but the A-node 22 is at a different company office 112. For the second case in the third category, demands are sent via the direct SONET link 38.

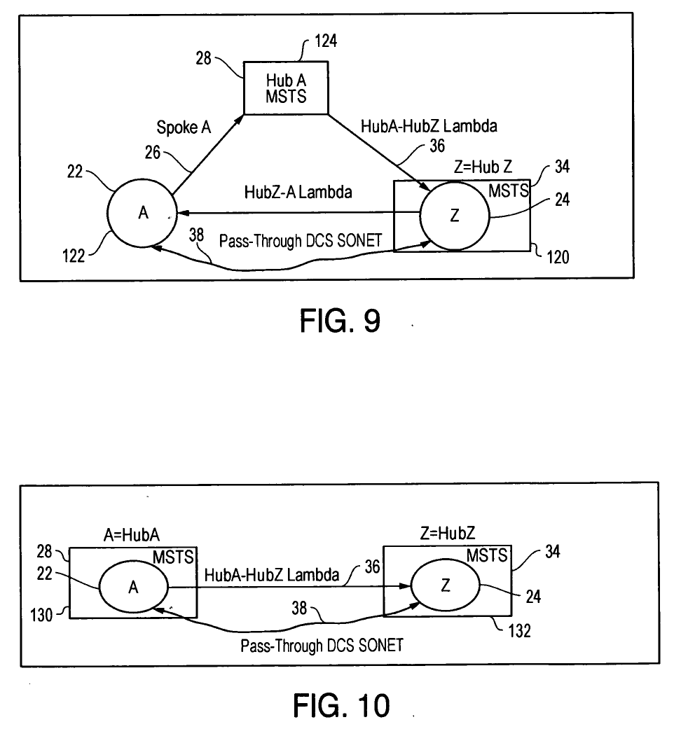

FIG. 9 is a block diagram of a fourth category of end-to-end demand. In the fourth category, the Z-node 24 and the hub-Z 34 are both at a company office 120, but the A-node 22 and the hub-A 28 are at two other company offices 122 and 124. For the fourth category, second-order hubbing is attempted, and remaining demands are sent via the direct SONET link 38.

FIG. 10 is a block diagram of a fifth category of end-to-end demand. In the fifth category, the A-node 22 and the hub-A 28 are both at a first company office 130, and the Z-node 24 and the hub-Z 34 are both at a second company office 132 other than the first company office 130. For the fifth category, second-order hubbing is attempted, and remaining demands are sent via the direct SONET link 38.

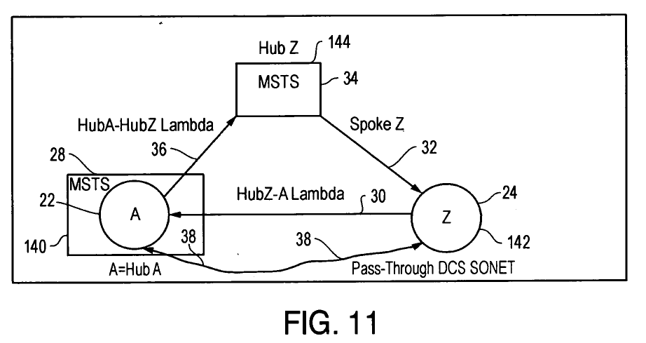

FIG. 11 is a block diagram of a sixth category of end-to-end demand. In the sixth category, the A-node 22 and the hub-A 28 are both at a company office 140, but the Z-node 24 and the hub-Z 34 are at two other company offices 142 and 144, respectively. For the sixth category, an attempt is made to dispatch qualifying demands via a first-order hubbing route. The first-order hubbing route does not involve the spoke-A 26 in this category. If this attempt fails, demands are sent via a second-order hubbing route. Thereafter, any remaining demands are sent via the direct SONET link 38.

By categorizing the end-to-end demands into a plurality of different categories based on the hubbing, grooming and gateway assignments in the telecommunication network, the types of links eligible for consideration are constrained. The category is based on the assignment of roles for the nodes, where some nodes may serve two or more roles (such as both an “A” endpoint and a “hub-Z”) for a given end-to-end demand, and is independent of quantities, thresholds and other assumptions and parameters. Thus, the final solution is constrained by the category.

Thus, groups of diverse rate demands originating in a common CO-A and terminating in a common CO-Z are assigned to a specific category based on the aforementioned hubbing rules. Using the category assignments, an optical (lambda) second-order grooming process can be performed such that lambda requirements for these logical demands need only once be optimally calculated.

Further, an allocation of the groomed demands between the two lambdas is greatly simplified using the categorization. The categorization allows identification of demands groups whose origin and destination central offices are candidates for direct lambda traffic between them. Individual demands in each of these demand groups that cannot be carried by a new direct optical link is assigned for possible consideration for either first and/or second-order hubbing based on their category.

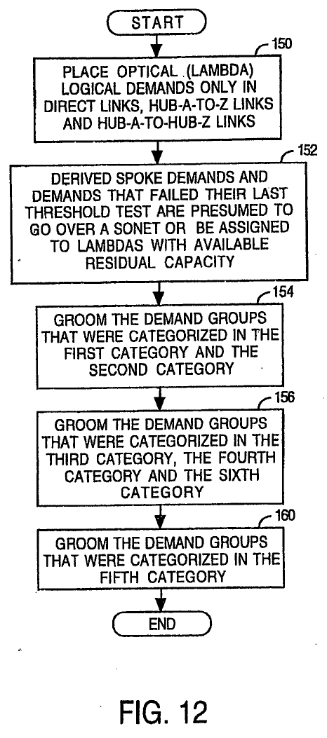

FIG. 12 is a flow chart of an embodiment of a method of grooming based on the six categories.

As indicated by block 150, the method comprises placing optical (lambda) logical demands only in direct links, hub-A-to-Z links and hub-A-to-hub-Z links.

As indicated by block 152, derived spoke demands and demands that failed their last threshold test are presumed to go over a SONET network or may be assigned to lambdas with available residual capacity.

As indicated by block 154, the method comprises grooming the demand groups that were categorized in the first category and the second category.

As indicated by block 156, the method comprises grooming the demand groups that were categorized in the third category, the fourth category and the sixth category. The grooming of these first-order grooming types is performed after all of the grooming indicated by block 154.

As indicated by block 160, the method comprises grooming the demand groups that were categorized in the fifth category. The grooming of this second-order grooming type is performed after all of the grooming indicated by blocks 154 and 156.

Using the method, lambda requirements can be calculated once for each A-Z pair during hubbing. Further, the optimization and sizing of the lambdas requires less bookkeeping and juggling of demands.

For purposes of illustration and example, consider a network comprising customer endpoints AJ, AS, J, K, S, X, Y, and Z, and company offices A, B, C, I, and P. The endpoints X, Y, and Z are off-net. The endpoints AS, AJ, K, J, and S are on-net. TABLE I shows the hubbing, grooming, and gateway relationships between the nodes in this example.

TABLE I

| | | | Hub | Gateway |
|---|---|---|---|---|
| Name | Type | Off/On Net | (if On) | (if Off) |
| A | Company Office | On | A | N/A |
| B | Company Office | On | B | N/A |
| AJ | Customer Endpoint | On | B | N/A |
| AS | Customer Endpoint | On | A | N/A |
| C | Company Office | On | C | N/A |
| I | Company Office | On | A | N/A |
| J | Customer Endpoint | On | B | N/A |
| K | Customer Endpoint | On | A | N/A |
| P | Company Office | On | C | N/A |
| S | Customer Endpoint | On | A | N/A |
| X | Customer Endpoint | Off | N/A | P |
| Y | Customer Endpoint | Off | N/A | I |
| Z | Customer Endpoint | Off | N/A | C |

TABLE II shows example demands at the STS-1 level that are to be consolidated and multiplexed to optical levels. End-to-end canonically-named demands are projected for end-of-year for the next three years.

TABLE II

| | | STS-1, | STS-1, | STS-1, | STS-1, |
|---|---|---|---|---|---|
| Endpoint A | Endpoint Z | EOY1 | EOY2 | EOY3 | EOY4 |
| I | J | 1 | 3 | 14 | 100 |
| I | P | 1 | 3 | 7 | 14 |
| K | S | 1 | 3 | 7 | 14 |
| C | X | 1 | 3 | 7 | 14 |
| AJ | B | 1 | 3 | 7 | 14 |
| AS | C | 1 | 3 | 7 | 14 |
| A | B | 1 | 3 | 7 | 14 |
| A | J | 1 | 3 | 7 | 14 |

Each demand is categorized according to its category.

The “I-J” demand corresponds to the first category. By exceeding the first threshold, the “I-J” demand qualifies for sending via a direct lambda.

The “I-P” demand also corresponds to the first category. The “I-P” demand fails to qualify for first-order hubbing, but qualifies for use of second-order hubbing. A second-order hubbing route comprising a spoke-A (“I-A”), a hub-A-to-hub-Z (“A-C”), and a hub-Z-to-Z (“C-P”) is used for this demand.

The “K-S” demand corresponds to the second category. A first-order hubbing path comprising a spoke-A (“K-A”) and a hub-A-to-Z (“A-S”) is used for this demand.

The “C-X” demand corresponds to the third category. Only a spoke-A (“C-X”) is used for this demand.

The “AJ-B” demand corresponds to the third category. Only a spoke-A (“AJ-B”) is used for this demand.

The “AS-C” demand corresponds to the fourth category. A route comprising a spoke-A (“AS-A”) and a hub-A-to-hub-Z (“A-C”) is used for this demand.

The “A-B” demand corresponds to the fifth category. Only a hub-A-to-hub-Z (“A-B”) is used for this demand.

The “A-J” demand corresponds to the sixth category. A route comprising a hub-A-to-hub-Z (“A-B”) and spoke-Z (“B-J”) is used for this demand.

TABLE III summarizes the categorization of the various demands.

TABLE III

| Endpoint A | Endpoint Z | Category |
|---|---|---|
| I | J | 1 |
| I | P | 1 |
| K | S | 2 |
| C | X | 3 |
| AJ | B | 3 |
| AS | C | 4 |
| A | B | 5 |
| A | J | 6 |

If any hubbing, grooming, and/or gateway assignments are modified, only demands involving reclassified nodes need to be reconsidered. Likewise, changing quantities or endpoints of the original end-to-end demands involves re-categorizing and reconsidering only the modified demands.

For example, if endpoint P re-specifies its hub from company office C to company office A, then the end-to-end demand “I-P” is re-categorized from the first category to the second category. Revised routing for “I-P” is immediately available in accordance with the second category. Only other first category demands that compare thresholds at intermediate nodes A and C are reevaluated according to adjusted aggregated totals.

As another example, if company office P is reclassified to be a hub office, then the end-to-end demand “I-P” is re-categorized as the first category. This immediately eliminates any consideration of a spoke-Z.

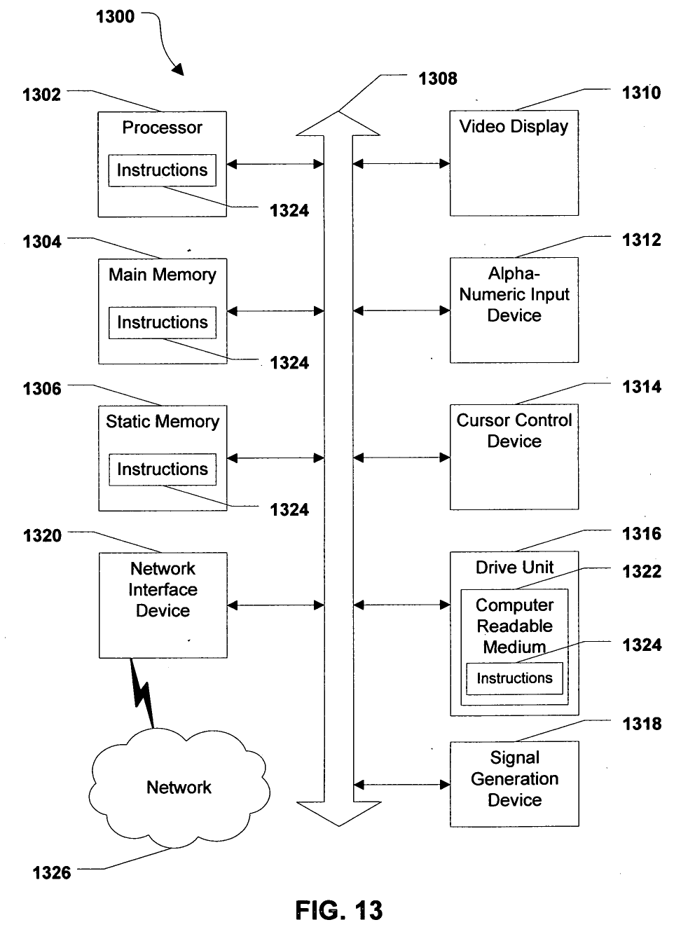

Referring to FIG. 13, an illustrative embodiment of a general computer system is shown and is designated 200. The computer system 200 can include a set of instructions that can-be executed to cause the computer system 200 to perform any one or more of the methods or computer based functions disclosed herein. The computer system 200 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 13, the computer system 200 may include a processor 202, e.g., a central processing unit (CPU), a graphics processing unit (GPU), or both. Moreover, the computer system 200 can include a main memory 204 and a static memory 206, that can communicate with each other via a bus 208. As shown, the computer system 200 may further include a video display unit 210, such as a liquid crystal display (LCD), an organic light emitting diode (OLED), a flat panel display, a solid state display, or a cathode ray tube (CRT). Additionally, the computer system 200 may include an input device 212, such as a keyboard, and a cursor control device 214, such as a mouse. The computer system 200 can also include a disk drive unit 216, a signal generation device 218, such as a speaker or remote control, and a network interface device 220.

In a particular embodiment, as depicted in FIG. 13, the disk drive unit 216 may include a computer-readable medium 222 in which one or more sets of instructions 224, e.g. software, can be embedded. Further, the instructions 224 may embody one or more of the methods or logic as described herein. In a particular embodiment, the instructions 224 may reside completely, or at least partially, within the main memory 204, the static memory 206, and/or within the processor 202 during execution by the computer system 200. The main memory 204 and the processor 202 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 224 or receives and executes instructions 224 responsive to a propagated signal, so that a device connected to a network 226 can communicate voice, video or data over the network 226. Further, the instructions 224 may be transmitted or received over the network 226 via the network interface device 220.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
categorizing each of a plurality of end-to-end demands between pairs of nodes of a telecommunication network into an associated category based on hubbing assignments, grooming assignments and gateway assignments for the nodes;
constraining which one or more links are eligible to be considered in determining a respective route for each of the end-to-end demands based on its associated category; and
using a hubbing-and-grooming algorithm to determine the respective routes for the end-to-end demands based on said constraining.

2. The method of claim 1, wherein the associated category is a first category for those of the end-to-end demands whose first node is at a first office, whose second node is at a second office, whose first node is assigned a first hub at a third office, and whose second node is assigned a second hub at a fourth office.

3. The method of claim 2, wherein for an end-to-end demand categorized in the first category, said using the hubbing-and-grooming algorithm comprises:
attempting to dispatch the end-to-end demand via a first-order hubbing route;
sending the end-to-end demand via a second-order hubbing route if said attempting fails; and
sending a remaining demand, if any, via a direct SONET link.

4. The method of claim 1, wherein the associated category is a first category for those of the end-to-end demands whose first node is at a first office, whose second node is at a second office, whose first node is assigned a first hub at a third office, and whose second node is assigned a second hub at the third office.

5. The method of claim 4, wherein for an end-to-end demand categorized in the first category, said using the hubbing-and-grooming algorithm comprises:
attempting to dispatch the end-to-end demand via a first-order hubbing route; and
sending a remaining demand, if any, via a direct SONET link.

6. The method of claim 1, wherein the associated category is a first category for those of the end-to-end demands whose first node is at a first office, whose second node is at a second office, whose first node is assigned a first hub at the first office, and whose second node is assigned a second hub at the first office.

7. The method of claim 6, wherein for an end-to-end demand categorized in the first category, said using the hubbing-and-grooming algorithm comprises:
sending the end-to-end demand via a direct SONET link.

8. The method of claim 1, wherein the associated category is a first category for those of the end-to-end demands whose first node is at a first office, whose second node is at a second office, whose first node is assigned a first hub at a third office, and whose second node is assigned a second hub at the second office.

9. The method of claim 8, wherein for an end-to-end demand categorized in the first category, said using the hubbing-and-grooming algorithm comprises:
attempting to dispatch the end-to-end demand via a second-order hubbing route; and
sending a remaining demand, if any, via a direct SONET link.

10. The method of claim 1, wherein the associated category is a first category for those of the end-to-end demands whose first node is at a first office, whose second node is at a second office, whose first node is assigned a first hub at the first office, and whose second node is assigned a second hub at the second office.

11. The method of claim 10, wherein for an end-to-end demand categorized in the first category, said using the hubbing-and-grooming algorithm comprises:
attempting to dispatch the end-to-end demand via a second-order hubbing route; and
sending a remaining demand, if any, via a direct SONET link.

12. The method of claim 1, wherein the associated category is a first category for those of the end-to-end demands whose first node is at a first office, whose second node is at a second office, whose first node is assigned a first hub at the first office, and whose second node is assigned a second hub at a third office.

13. The method of claim 12, wherein for an end-to-end demand categorized in the first category, said using the hubbing-and-grooming algorithm comprises:
attempting to dispatch the end-to-end demand via a first-order hubbing route that does not include a spoke-A link;
sending the end-to-end demand via a second-order hubbing route if said attempting fails; and
sending a remaining demand, if any, via a direct SONET link.

14. The method of claim 1, further comprising:
modifying at least one parameter of the telecommunication network;
re-categorizing at least one of the end-to-end demands based on said modifying; and
reconsidering only those end-to-end demands whose category has changed based on said re-categorizing for revision of their respective routes.

15. The method of claim 14, wherein said modifying comprises modifying at least one of the hubbing assignments.

16. The method of claim 14, wherein said modifying comprises modifying at least one of the grooming assignments.

17. The method of claim 14, wherein said modifying comprises modifying at least one of the gateway assignments.

18. The method of claim 14, wherein said modifying comprises changing at least one endpoint for at least one of the end-to-end demands.

19. The method of claim 1, wherein said using the hubbing-and-grooming algorithm comprises:
if an aggregated demand between an A-node and a Z-node for a target time interval equals or exceeds a first threshold, determining whether all or some of the aggregated demand between the A-node and the Z-node is to be sent via a direct lambda route based on at least one rule.

20. The method of claim 19, wherein the at least one rule comprises a rule of attempting to maximize a utilization of lambda routes.

21. The method of claim 19, wherein the at least one rule comprises a rule of processing demands in a demand group based on a highest demand.

22. The method of claim 19, wherein the at least one rule comprises a rule of providing a higher lambda route when the aggregated demand exceeds a second threshold.

23. The method of claim 19, wherein the at least one rule comprises a rule of upgrading a route to a second lambda if more than a capacity equivalent to a fixed multiple of a first lambda is required for the aggregated demand.

24. The method of claim 19, wherein the at least one rule comprises a rule of decreasing a remaining aggregated equivalent demand under consideration for direct routing after a demand is assigned to the direct lambda route.

25. The method of claim 19, wherein said using the hubbing-and-grooming algorithm comprises:
considering at least one indirect lambda route between the A-node and the Z-node when the aggregated demand between the A-node and the Z-node for the target time interval is less than the first threshold.

26. The method of claim 19, wherein said using the hubbing-and-grooming algorithm comprises:
considering at least one indirect lambda route between the A-node and the Z-node when a rule for use of the direct lambda route has failed.

27. The method of claim 1, wherein said categorizing is into one of a plurality of categories comprising at least one first-order grooming category and at least one second-order grooming category.

28. The method of claim 27, wherein said using the hubbing-and-grooming algorithm comprises:
grooming all of the demands categorized in the at least one first-order grooming category, and thereafter grooming all of the demands categorized in the at least one second-order grooming category.

29. The method of claim 1, wherein said categorizing is into one of a plurality of categories that comprise a first category, a second category, a third category, a fourth category, a fifth category and a sixth category.

30. The method of claim 29, wherein said using the hubbing-and-grooming algorithm comprises:
first grooming all of the demands categorized in the first category and the second category;
after said first grooming, second grooming all of the demands categorized in the third category, the fourth category and the sixth category; and
after said second grooming, third grooming all of the demands categorized in the fifth category.

31. A computer-readable medium having computer-readable program code to direct a computer to perform acts of:
categorizing each of a plurality of end-to-end demands between pairs of nodes of a telecommunication network into an associated category based on hubbing assignments, grooming assignments and gateway assignments for thee nodes;
constraining which one or more links are eligible to be considered in determining a respective route for each of the end-to-end demands based on its associated category; and
using a hubbing-and-grooming algorithm to determine the respective routes for the end-to-end demands based on said constraining.

32. A computer system comprising:
a computer processor programmed to:
categorize each of a plurality of end-to-end demands between pairs of nodes of a telecommunication network into an associated category based on hubbing assignments, grooming assignments and gateway assignments for the nodes;
constrain which one or more links are eligible to be considered in determining a respective route for each of the end-to-end demands based on its associated category; and
use a hubbing-and-grooming algorithm to determine the respective routes for the end-to-end demands as constrained based on their associated categories.

33. A method comprising:
categorizing an end-to-end demand between a first node and a second node of a telecommunication network into a category of a plurality of different categories, said categorizing being based on at least one hub assignment for the first node and the second node;
constraining which one or more links are eligible to be considered in determining a route for the end-to-end demand based on the category; and
determining the route for the end-to-end demand based on the category.
